(19) United States
(12) Patent Application Publication
(10) Pub. No.: US 2009/0298997 A1
(43) Pub. Date: Dec. 3, 2009

(54) AQUEOUS POWDER DISPERSION, WHICH CAN BE CURED BY RADICAL POLYMERIZATION, METHOD FOR THE PRODUCTION THEREOF AND THEIR USE

(75) Inventors: Hubert Baumgart, Munster (DE); Berthold Austrup, Nordkirchen (DE); Bostjan Muhic, Ljubljana (SI)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/097,120

(22) PCT Filed: Nov. 9, 2006
(86) PCT No.: PCT/EP2006/010718

§ 371 Date: Jul. 8, 2009

(30) Foreign Application Priority Data
Nov. 10, 2005 (DE) 10 2005 053 663.8

(51) Int. Cl. C09D 5/03

(52) U.S. Cl. 524/556

(57) ABSTRACT

Aqueous, structurally viscous powder dispersions curable by free-radical polymerization, substantially or entirely free from volatile organic compounds, and comprising as their disperse phase solid and/or highly viscous particles (A) which are dimensionally stable under storage and application conditions and have a z-mean average particle size as measured by photon correlation spectroscopy of 80 to 750 nm, the particles (A) comprising at least one free-radically crosslinkable binder (A1) having a glass transition temperature of −70 to +50° C., an olefinically unsaturated double bond content of 2 to 10 eq/kg and an acid group content of 0.05 to 15 eq/kg, in an amount, based on (A), of 50 to 100% by weight; process for their preparation, and their use.

### FIELD OF THE INVENTION

The present invention relates to new aqueous powder dispersions curable by free-radical polymerization. The present invention also relates to a new process for preparing aqueous powder dispersions curable by free-radical polymerization. The present invention further relates to the use of the new aqueous powder dispersions curable by free-radical polymerization and of the aqueous powder dispersions curable by free-radical polymerization and prepared by the new process as coating materials, adhesives, and sealants for producing coatings, adhesive layers, and seals.

### PRIOR ART

Aqueous powder dispersions, especially aqueous powder coating dispersions, are also referred to by those in the art, conventionally, as “powder slurries” or, for short, as “slurries”.

The term “slurries” here and below refers for the sake of brevity to powder slurries curable by free-radical polymerization.

Free-radical polymerization, conventionally, is carried out with compounds which contain olefinically unsaturated double bonds. The free-radical polymerization can be initiated and maintained thermally or with actinic radiation.

Actinic radiation here and below means electromagnetic radiation, such as near infrared (NIR), visible light, UV radiation, X-radiation or gamma radiation, especially UV radiation, or particulate radiation, such as electron beams, proton beams, beta radiation, alpha radiation or neutron beams, especially electron beams.

The U.S. Pat. No. 6,432,490 B1 or the corresponding international patent application WO 02/064267 A2 discloses slurries which comprise ionically stabilized urethane acrylates having an unsaturated double bond content or double bond equivalent weight of 0.1 to 10 eq/kg.

Further details of the ionic stabilization, however, are lacking, and the examples disclose only a conventional clearcoat material based on organic solvents and a urethane acrylate which is free of acid groups.

Following their application, the known slurries can be cured with near infrared to give hard, solvent-resistant, and yellowing-free coatings, especially clearcoats.

German patent application DE 199 08 013 A1 discloses structurally viscous slurries whose solid, spherical particles are found by the laser diffraction method to have an average size of 0.8 to 20 μm and a maximum size of 30 μm.

The constituents of the known slurries that are curable with actinic radiation contain ion-forming groups, particularly carboxyl groups, in an amount of 0.05 to 1 eq/kg, and neutralizing agents in an amount of 0.05 to 1 eq/kg.

The known slurries have a viscosity of 50 to 1000 mPas at a shear rate of 1000 s⁻¹, 150 to 8000 mPas at a shear rate of 10 s⁻¹, and 180 to 12 000 mPas at a shear rate of 1 s⁻¹.

The examples, however, disclose only a urethane acrylate having a double bond equivalent weight of 3 eq/kg but containing no acid groups. It is present in the particles of the slurry in question in an amount of 41.53% by weight, based on solids.

Following their application, the known slurries can be cured with UV radiation to give coatings, especially clearcoats, which have outstanding appearance, high chemical resistance, a high level of hardness, and a smooth surface. Even at film thicknesses of 40 to 50 μm they exhibit no pops and are free from mud cracking.

Nevertheless, the profile of performance properties of the known slurries requires constant ongoing development in order to satisfy the ever-higher requirements of the market. In particular it is necessary to develop the coatings produced from the known slurries, especially clearcoats, with regard to their chemical resistance, stonechip resistance, scratch resistance, and condensation resistance.

### Problem Addressed

It is an object of the present invention to find new aqueous powder dispersions curable by free-radical polymerization (and referred to collectively below as “new slurries”) which can be prepared easily and very reproducibly.

In the absence of actinic radiation the new slurries ought to be particularly stable on storage with no propensity to settle and/or agglomerate. Should any slight sedimentation and/or agglomeration of particles occur, nevertheless, after a prolonged period, it ought to be possible to disperse the sedimented particles again rapidly by brief stirring and to comminute the agglomerated particles again rapidly.

The new slurries ought to produce coatings, especially clearcoats, which have outstanding appearance properties, in particular a high gloss. They ought to be particularly resistant to chemicals, condensation, and mechanical exposure, particularly that from stone impact. They ought additionally to be highly scratch resistant. Furthermore, they ought effectively to level out unevennesses in the substrate that show through to the topmost coating of a multicoat paint system, and so ought to exhibit a particularly smooth and defect-free surface. In particular, however, they ought to remain free from pops and mud cracking even at particularly high film thicknesses of more than 80 μm.

### Solution

Found accordingly have been the new aqueous, structurally viscous powder dispersions curable by free-radical polymerization, substantially or entirely free from volatile organic compounds, and comprising as their disperse phase solid and/or highly viscous particles (A) which are dimensionally stable under storage and application conditions and have a z-mean average particle size as measured by photon correlation spectroscopy of 80 to 750 nm, the particles (A) comprising at least one free-radically crosslinkable binder (A1) having a glass transition temperature of −70 to +50° C., an olefinically unsaturated double bond content of 2 to 10 eq/kg and an acid group content of 0.05 to 15 eq/kg, in an amount, based on (A), of 50 to 100% by weight.

The new aqueous, structurally viscous powder dispersions curable by free-radical polymerization and free substantially or entirely from volatile organic compounds are referred to below as “slurries of the invention”.

Also found has been the new process for preparing the slurries of the invention, which involves dispersing the particles (A) in an aqueous medium (B), and which is referred to below as “process of the invention”.

Also found has been the new use of the slurries of the invention and of the slurries prepared by the process of the invention, as coating materials, adhesives, and sealants, for producing coatings, adhesive layers, and seals, this being referred to below as “inventive use”.

Additional subject matter of the invention will become apparent from the description.

### ADVANTAGES

In the light of the prior art it was surprising and unforeseeable for the skilled worker that the object on which the present invention was based could be achieved by means of the slurries of the invention, the process of the invention, and the inventive use.

In particular it was surprising that the slurries of the invention were preparable easily and with very good reproducibility.

In the absence of actinic radiation the slurries of the invention were particularly stable on storage and exhibited no propensity to settle and/or agglomerate. Nevertheless, where there was any slight sedimentation and/or agglomeration of particles (A) after a prolonged period, the sedimented particles (A) were rapidly redispersible by brief stirring and the agglomerated particles (A) could be comminuted rapidly again.

The slurries of the invention gave coatings of the invention, especially clearcoats of the invention, which had outstanding appearance properties, in particular a high gloss. They were particularly resistant to chemicals, condensation, and mechanical exposure, in particular that from stone chipping. Furthermore, they were highly scratch resistant. Moreover, they effectively leveled unevennesses in the substrate, which otherwise showed through to the topmost coating of a multicoat paint system, and therefore they had a particularly smooth and defect-free surface. In particular, however, they remained free from pops and mud cracking even at particularly high film thicknesses of more than 80 μm.

### DETAILED DESCRIPTION OF THE INVENTION

The slurry of the invention is entirely or substantially free from organic solvents.

“Substantially free” means that the slurry of the invention in question has a solvent content <10%, preferably in each case <5%, and in particular <2% by weight.

“Entirely free from” means that the solvent content is in each case below the customary, known detection limits for organic solvents.

The slurry of the invention is structurally viscous.

The viscosity behavior referred to as “structurally viscous” describes a state which takes account, on the one hand, of the needs of application and also, on the other hand, of the requirements in terms of storage stability and settling stability of the slurry of the invention: In the mobile state, such as when the slurry of the invention is being pumped around in the circuit of a coating plant, for example, and during application, the slurry of the invention adopts a low-viscosity state which ensures good processing properties. In the absence of shearing stress, in contrast, the viscosity increases and hence ensures that the slurry of the invention already on the substrate to be coated exhibits a reduced tendency to sag on vertical surfaces (“curtaining”). In the same way, the higher viscosity in the immobile state, such as during storage, for instance, means that settling of the solid particles (A) is very largely prevented or ensures that, in the event of any slight settling and/or agglomeration during the storage period, the slurry of the invention can be re-established by agitation.

The structurally viscous behavior is set preferably by means of suitable thickeners (A2), especially nonionic and ionic thickeners (A2), which are preferably in the aqueous phase (B).

For the structurally viscous behavior it is preferred to set a viscosity range of 50 to 1500 mPas at a shear rate of 1000 s⁻¹ and of 150 to 8000 mPas at a shear rate of 10 s⁻¹ and also of 180 to 12 000 mPas at a shear rate of 1 s⁻¹.

The slurry of the invention comprises as its disperse phase solid and/or highly viscous, dimensionally stable particles (A).

“Dimensionally stable” means that, under the customary, known conditions of the storage and application of structurally viscous, aqueous powder dispersions, the particles (A) exhibit only slight agglomeration and/or breakdown into smaller particles, if any at all, but instead substantially or entirely preserve their original form even under the influence of shearing forces.

The particles (A) have a z-mean average particle size as measured by photon correlation spectroscopy of 80 to 750 nm, preferably 80 to 600 nm, and in particular 80 to 400 nm.

Photon correlation spectroscopy is a customary, known method of measuring dispersed particles having sizes <1 μm. The measurement can be conducted, for example, by means of the Malvern® Zetasizer 1000.

The particle size distribution can be adjusted in any desired way. The particle size distribution results preferably from the use of suitable wetting agents (A2).

The amount of particles (A) in the slurry of the invention may vary very widely and is guided by the requirements of the case in hand.

Preferably the amount is 5% to 70%, more preferably 10% to 60%, very preferably 15% to 50%, and in particular 15% to 40% by weight, based on the slurry of the invention.

The particles (A) comprise at least one, especially one, free-radically crosslinkable binder (A1) having
a glass transition temperature of −70 to +50° C., preferably −60 to +20° C., and in particular −60 to +10° C.,
an olefinically unsaturated double bond content of 2 to 10 eq/kg, preferably 2 to 8 eq/kg, more preferably 2.1 to 6 eq/kg, very preferably 2.2 to 6 eq/kg, with very particular preference 2.3 to 5 eq/kg, and in particular 2.5 to 5 eq/kg of the binder (A1), and
an acid group content of 0.05 to 15 eq/kg, preferably 0.08 to 10 eq/kg, more preferably 0.1 to 8 eq/kg, very preferably 0.15 to 5 eq/kg, with very particular preference 0.18 to 3 eq/kg, and in particular 0.2 to 2 eq/kg of the binder (A1).

The amount of acid groups is determined preferably via the acid number in accordance with DIN EN ISO 3682.

The particles (A) contain the binders (A1) in an amount of 50% to 100%, preferably 55% to 100%, more preferably 60% to 99%, very preferably 70% to 99%, and in particular 80% to 99% by weight, based in each case on (A).

The particles (A) may therefore consist of the binder (A1). With preference the particles (A) further comprise at least one of the additives (A2) described below. The olefinically unsaturated double bonds of the binder (A1) are preferably in groups selected from the group consisting of (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, preferably (meth)acrylate groups. In particular the olefinically unsaturated double bonds are in acrylate groups.

The binders (A1) are oligomeric or polymeric.

“Oligomeric” means that the binder (A1) in question is composed of 3 to 12 monomeric structural units.

“Polymeric” means that the binder (A1) in question is composed of more than 8 monomeric structural units.

Whether a binder (A1) composed of 8 to 12 monomeric structural units is regarded as being an oligomer or a polymer depends primarily on its number-average molecular weight.

The number-average molecular weight of the binder (A1) may vary very widely and is guided by the requirements of the case in hand, in particular by the viscosity which is advantageous for the processing and the use of the binder (A1). The viscosity of the binder (A1), accordingly, is typically adjusted so that after the slurry of the invention has been applied and the resulting wet film dried, filming of the particles (A) is achieved easily and without problems.

The number-average molecular weight is preferably 1000 to 50 000 daltons, more preferably 1500 to 40 000 daltons, and in particular 2000 to 20 000.

The polydispersity of the molecular weight may likewise vary very widely and is preferably 1 to 10, in particular 1.5 to 8.

Suitable binders (A1) include all oligomers and polymers which have the profile of properties described above.

The binder (A1) is selected preferably from the group consisting of oligomeric and polymeric epoxy(meth)acrylates, urethane (meth)acrylates, and carbonate (meth)acrylates. Urethane (meth)acrylates are used in particular.

The urethane (meth)acrylates (A1) are prepared by reacting
(a1) at least one compound containing at least two isocyanate groups and selected from the group consisting of aliphatic, aromatic or cycloaliphatic di- and polyisocyanates with
(a2) at least one compound having at least one, especially one, isocyanate-reactive functional group, selected preferably from the group consisting of hydroxyl groups, thiol groups, and primary and secondary amino groups, especially hydroxyl groups, and at least one, especially one, of the above-described groups which contain a free-radically polymerizable olefinically unsaturated double bond, preferably a (meth)acrylate group, in particular an acrylate group,
(a3) at least one compound having at least one, especially one, isocyanate-reactive functional group and at least one, especially one, acid group, selected preferably from the group consisting of carboxylic, phosphonic, phosphinic, sulfonic, and sulfinic acid groups, preferably carboxylic and sulfonic acid groups, especially carboxylic acid groups, and also
(a4) if desired, at least one compound having at least two, especially two, isocyanate-reactive functional groups.

Examples of suitable compounds (a1) are customary, known di- and polyisocyanates having an isocyanate functionality of on average 2 to 6, preferably 2 to 5, and in particular 2 to 4.

“Aliphatic” means that the isocyanate group in question is linked to an aliphatic carbon atom.

“Cycloaliphatic” means that the isocyanate group in question is linked to a cycloaliphatic carbon atom.

“Aromatic” means that the isocyanate group in question is linked to an aromatic carbon atom.

Examples of suitable aliphatic diisocyanates (a1) are aliphatic diisocyanates, such as tetramethylene diisocyanate, pentamethylene diisocyanate, hexamethylene diisocyanate, octamethylene diisocyanate, decamethylene diisocyanate, dodecamethylene diisocyanate, tetradecamethylene diisocyanate, derivatives of lysine diisocyanate, tetramethylxylylidene diisocyanate, trimethylhexane diisocyanate or 1,3- or 1,4-bis(isocyanatomethyl)cyclohexane.

Examples of suitable cycloaliphatic diisocyanates (a1) are 1,4-, 1,3- or 1,2-diisocyanatocyclohexane, tetramethylcyclohexane diisocyanate, bis(4′-isocyanatocyclohexyl)methane, (4′-isocyanatocyclohexyl)(2′-isocyanatocyclohexyl)-methane, 2,2-bis(isocyanatocyclohexyl)propane, 2,2-(4′-isocyanatocyclohexyl)-(2′-isocyanatocyclohexyl)propane, 1-isocyanato-3,3,5-trimethyl-5-(isocyanatomethyl)-cyclohexane (isophorone diisocyanate), 2,4- or 2,6-diisocyanato-1-methylcyclohexane or diisocyanates derived from dimer fatty acids, such as are sold under the tradename DDI 1410 by Henkel and described in patents WO 97/49745 and WO 97/49747, such as 2-heptyl-3,4-bis(9-isocyanatononyl)-1-pentylcyclohexane.

Examples of suitable aromatic diisocyanates (a1) are 2,4- or 2,6-tolylidene diisocyanate or their isomer mixtures, m- or p-xylylene diisocyanate, 2,4′- or 4,4′-diisocyanatodiphenylmethane or their isomer mixtures, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyl-diphenylmethane 4,4′-diisocyanate, 1,4-diisocyanatobenzene or 4,4′-diisocyanato-diphenyl ether.

Preference is given to using aliphatic and cycloaliphatic diisocyanates (a1), especially hexamethylene diisocyanate, 1,3-bis(isocyanatomethyl)cyclohexane, isophorone diisocyanate and/or di(isocyanatocyclohexyl)methane.

Examples of suitable polyisocyanates (a1) are triisocyanates such as nonane triisocyanate (NTI) and also polyisocyanates (a1) based on the above-described diisocyanates and triisocyanates (a1), especially oligomers containing isocyanurate, biuret, allophanate, iminooxadiazinedione, urethane, carbodiimide, urea, uretonimine and/or uretdione groups. Examples of suitable such polyisocyanates (a1), and processes for preparing them, are disclosed for example in patents and patent applications CA 2,163,591 A 1, U.S. Pat. No. 4,419,513 A, U.S. Pat. No. 4,454,317 A, EP 0 646 608 A 1, U.S. Pat. No. 4,801,675 A, EP 0 183 976 A 1, DE 40 15 155 A 1, EP 0 303 150 A 1, EP 0 496 208 A 1, EP 0 524 500 A 1, EP 0 566 037 A 1, U.S. Pat. No. 5,258,482 A, U.S. Pat. No. 5,290,902 A, EP 0 649 806 A 1, DE 42 29 183 A 1 or EP 0 531 820 A 1.

Preference is given to using the oligomers (a1) of hexamethylene diisocyanate and of isophorone diisocyanate.

Examples of suitable compounds (a2) are the monoesters of
(a21) diols and polyols containing preferably 2 to 20 carbon atoms and at least 2 hydroxyl groups in the molecule, such as ethylene glycol, diethylene glycol, triethylene glycol, 1,2-propylene glycol, 1,3-propylene glycol, 1,1-dimethyl-1,2-ethanediol, dipropylene glycol, tripropylene glycol, tetraethylene glycol, pentaethylene glycol, 1,4-butanediol, 1,5-pentanediol, neopentyl glycol, 1,6-hexanediol, 2-methyl-1,5-pentanediol, 2-ethyl-1,4-butanediol, 1,4-dimethyl-olcyclohexane, 2,2-bis(4-hydroxycyclohexyl)propane, glycerol, trimethylolethane, trimethylolpropane, pentaerythritol, dipentaerythritol, ditrimethylolpropane, erythritol, sorbitol, polytetrahydrofuran having an average molecular weight of 162 to 2000, poly-1,3-propanediol having an average molecular weight of 134 to 400 or polyethylene glycol having a molecular weight of between 150 and 500, especially ethylene glycol; with
(a22) alpha,beta-unsaturated carboxylic acids, such as acrylic acid, methacrylic acid, crotonic acid, itaconic acid, fumaric acid, maleic acid, acrylamidoglycolic acid, and methacrylamidoglycolic acid, especially acrylic acid.

Further examples of suitable compounds (a2) are the monovinyl ethers of the above-described diols and polyols (a21).

Further examples of suitable compounds (a2) are the monoesters or monoamides of the above-described alpha,beta-unsaturated carboxylic acids (a22) with
(a23) amino alcohols, such as 2-aminoethanol, 2-(methylamino)ethanol, 3-amino-1-propanol, 1-amino-2-propanol or 2-(2-aminoethoxy)ethanol,
(a24) thioalcohols, such as 2-mercaptoethanol, or
(a25) polyamines, such as ethylenediamine or diethylenetriamine.

In particular, 2-hydroxyethyl acrylate is used.

Examples of suitable compounds (a3) are
(a31) hydroxy carboxylic acids, such as hydroxyacetic acid (glycolic acid), 2- or 3-hydroxypropionic acid, 3- or 4-hydroxybutyric acid, hydroxypivalic acid, 6-hydroxycaproic acid, citric acid, malic acid, tartaric acid, 2,3-dihydroxypropionic acid (glyceric acid), dimethylolpropionic acid, dimethylolbutyric acid, trimethylolacetic acid, salicylic acid, 3- or 4-hydroxybenzoic acid or 2-, 3- or 4-hydroxycinnamic acid,
(a32) amino acids, such as 6-aminocaproic acid, aminoacetic acid (glycine), 2-aminopropionic acid (alanine), 3-aminopropionic acid (beta-alanine) or the other essential amino acids; N,N-bis(2-hydroxyethyl)glycine, N-[bis(hydroxymethyl)-methyl]glycine or imidodiacetic acid,
(a33) sugar acids, such as gluconic acid, glucaric acid, glucuronic acid, galacturonic acid or mucic acid (galactaric acid),
(a34) thiol carboxylic acids, such as mercaptoacetic acid, or
(a35) sulfonic acids, such as 2-aminoethanesulfonic acid (taurine), aminomethanesulfonic acid, 3-aminopropanesulfonic acid, 2-[4-(2-hydroxyethyl)-1-piperazinyl]ethanesulfonic acid, 3-[4-(2-hydroxyethyl)piperazinyl]propanesulfonic acid, N-[tris(hydroxymethyl)methyl]-2-aminoethanesulfonic acid, N,N-bis(2-hydroxyethyl)-2-aminoethanesulfonic acid, 5-sulfosalicylic acid, 8-hydroxyquinoline-5-sulfonic acid, phenol-4-sulfonic acid or sulfanilic acid.

In particular, hydroxyacetic acid (glycolic acid) (a31) is used.

The acid groups may be in ionized form.

Examples of suitable counterions are lithium, sodium, potassium, rubidium, cesium, magnesium, strontium, barium or ammonium ions and also primary, secondary, tertiary or quaternary ammonium ions deriving from customary, known organic amines.

Examples of suitable compounds (a4) are the above-described diols and polyols (a21), amino alcohols (a23), thioalcohols (a24) or polyamines (a25).

The urethane (meth)acrylates (A1) are preferably prepared by reacting compounds (a1), (a2) and (a3) and also, if desired, (a4) with one another in a molar ratio such that for 3 equivalent isocyanate groups from the compound (a1) there are
0.5 to 3, preferably 0.8 to 2.5, more preferably 1.0 to 2.2, and in particular 1.4 to 1.8 equivalents of isocyanate-reactive functional groups from compound (a2) and
0.001 to 1.5, preferably 0.005 to 1.0, more preferably 0.01 to 0.8, and in particular 0.1 to 0.5 equivalents of isocyanate reactive functional groups from the compound (a3), and, if desired,
0 to 2, preferably 0.1 to 1.8, more preferably 0.5 to 1.5, and in particular 0.8 to 1.3 equivalents of isocyanate-reactive functional groups from the compound (a4).

Viewed in terms of method the preparation of the urethane (meth)acrylates (A1) has no peculiarities but instead takes place under the customary, known conditions of the reaction of polyisocyanates in the absence of water at temperatures of 5 to 100° C. In order to inhibit polymerization of the olefinically unsaturated double bonds it is preferred to operate under an oxygenous gas, in particular under air or air/nitrogen mixtures.

The slurry of the invention is composed of at least one disperse phase (A) and a continuous aqueous phase (B). In the simplest case the disperse phase (A) is composed of the binder (A1) and the continuous phase (B) is composed of water. Preferably, however, the slurry of the invention further comprises at least one customary, known additive (A2) in customary, known amounts.

Depending on its physicochemical properties an additive (A2) may be in the disperse phase (A), i.e., the dimensionally stable particles (A); alternatively, it may also form a separate disperse phase (A2), such as a pigment, for example. In addition it may be exclusively in the aqueous phase (B), such as a water-soluble salt, for example, or may accumulate at the interface between aqueous phase (B) and disperse phase (A), such as a wetting agent, for example. It is possible not least for the additive (A2) to partition itself between the disperse phase (A) and the aqueous phase (B), such as a molecularly dispersely dissolved organic dye, for example. The skilled worker therefore has the capacity to predict, simply, how an additive (A2) will behave in the slurry of the invention.

The additive (A2) is preferably selected from the group consisting of salts which can be decomposed thermally without, or substantially without, residue; binders other than the binders (B) and curable physically, thermally and/or with actinic radiation; neutralizing agents; thermally curable reactive diluents; reactive diluents curable with actinic radiation; opaque and transparent, color and/or effect pigments; molecularly dispersely soluble dyes; opaque and transparent fillers; nanoparticles; light stabilizers; antioxidants; devolatilizers; wetting agents; emulsifiers; slip additives; polymerization inhibitors; free-radical polymerization initiators, especially photoinitiators; thermolabile free-radical initiators; adhesion promoters; flow control agents; film-forming assistants; rheological assistants, such as thickeners and structurally viscous sag control agents, SCAs; flame retardants; corrosion inhibitors; free-flow aids; waxes; siccatives; biocides; and matting agents.

With preference the slurry of the invention comprises salts which can be decomposed thermally without, or substantially without, residue, light stabilizers, wetting agents, emulsifiers, flow control agents, photoinitiators, and rheological assistants as additives (A2).

If it is to be used as a clearcoat slurry the slurry of the invention preferably contains no opaque constituents, in particular no opaque pigments or fillers.

Examples of suitable additives (A2) are known from German patent applications
DE 101 26 649 A1, page 16, paragraph [0145], to page 18, paragraph [0189],
DE 100 27 270 A1, page 11, paragraphs [0106] and [0107], or
DE 101 35 997 A1, page 3, paragraph [0022], to page 4, paragraph [0033], and page 4, paragraphs [0039] and [0040], page 10, paragraphs [0092] to [0101].

Where the slurry of the invention includes thermally curable constituents they are present in the dimensionally stable particles (A) preferably in an amount <40%, more preferably <30%, and in particular <20% by weight.

The slurry of the invention is prepared preferably by the secondary dispersion process known from German patent application DE 199 08 013 A 1, German patent DE 198 41 842 C 2 or German patent application DE 100 55 464 A 1.

In that process the ionically stabilizable binders (A1) and also, if desired, the additives (A2) are dissolved in organic solvents, particularly water-miscible solvents which are highly volatile. The resulting solutions are dispersed with the aid of neutralizing agents (A2) in water. Dilution then takes place with water, accompanied by stirring. The initial product is a water-in-oil emulsion, which on further dilution undergoes inversion to give an oil-in-water emulsion. This inversion point is generally reached at solids contents of <50% by weight, based on the emulsion, and can be recognized externally from a relatively sharp drop in viscosity in the course of dilution.

The oil-in-water emulsion can also be prepared directly by the melt emulsification of the binders (A1) and also, where appropriate, of the additives (A2) in water.

It is of advantage in this context if the wetting agents (A2) are added to the organic solution and/or to the water before or during emulsification. Preferably they are added to the organic solution.

The emulsion thus obtained, which still contains solvents, is subsequently freed from solvents by means of azeotropic distillation.

In accordance with the invention it is of advantage if the solvents to be removed are distilled off at a distillation temperature below 70° C., preferably below 50° C., and in particular below 40° C. Where appropriate the distillation pressure in this case is chosen such that in the case of relatively high-boiling solvents the temperature is maintained within this range.

In the simplest case the azeotropic distillation can be brought about by stirring the emulsion at room temperature in the open vessel for a number of days. In the preferred case the solvent-containing emulsion is freed from the solvents by means of vacuum distillation.

In order to avoid high viscosities, the quantity of water and solvents removed by evaporation or distillation is replaced by water. The water can be added before, after or else during the evaporation or distillation, and can be added in portions. Following the loss of solvents there is a rise in the glass transition temperature of the dispersed dimensionally stable particles, and instead of the previous solvent-containing emulsion the structurally viscous aqueous dispersion (B) is formed, i.e., the slurry (A) of the invention.

Where appropriate the dimensionally stable particles are mechanically comminuted in the wet state, an operation also referred to as wet grinding. In this context it is preferred to employ conditions such that the temperature of the material for grinding does not exceed 70° C., more preferably 60° C., and in particular 50° C. The specific energy input during the grinding operation is preferably 10 to 1000, more preferably 15 to 750, and in particular 20 to 500 Wh/g.

Wet grinding can be carried out employing any of a very wide variety of apparatus, which generate high or low shearfields.

Examples of suitable apparatus generating low shear fields are customary, known stirred tanks, slot homogenizers, microfluidizers or dissolvers.

Examples of suitable apparatus generating high shear fields are customary, known agitator mills or inline dissolvers.

Particular preference is given to employing apparatus which generate high shear fields. Of these apparatus, the agitator mills are particularly advantageous in accordance with the invention and are therefore used with very particular preference.

In the case of wet grinding, generally speaking, the slurry of the invention is supplied to the above-described apparatus with the aid of suitable devices, such as pumps, especially gear pumps, and is circulated via said apparatus until the desired particle size has been reached.

The slurry of the invention is preferably filtered before being used. This is done using the customary, known filtration equipment and filters. The mesh size of the filters may vary widely and is guided primarily by the particle size and particle size distribution. The skilled worker is therefore able easily to determine the appropriate filters on the basis of this physical parameter. Examples of suitable filters are monofilament flat filters or bag filters. They are available on the market under the brand names Pong® or Cuno®.

The slurry of the invention can be applied outstandingly by means of the customary, known methods of applying liquid coating materials, such as injecting, spraying, knife coating, spreading, pouring, dipping, trickling or rolling, for example. Preference is given to employing spray application methods. It is preferred to exclude actinic radiation during application.

Following its application, the slurry of the invention dries without problems and exhibits filming at the processing temperature, generally at room temperature. In other words, the slurry of the invention, applied as a wet film, loses water when flashed off at room temperature or slightly elevated temperatures, with the particles present therein changing their original form and coalescing to form a homogeneous film (A). Alternatively the applied slurry of the invention may dry in powder form.

Drying can be accelerated through the use of a gaseous, liquid and/or solid, hot medium, such as hot air, heated oil or heated rolls, or of microwave radiation, infrared light and/or near infrared (NIR) light. Preferably the wet film is dried in a forced-air oven at 23 to 150° C., more preferably 30 to 120° C., and in particular 50 to 100° C.

Thereafter the dried film (A) of the invention is cured by free-radical polymerization.

The free-radical polymerization may be initiated and maintained thermally. In that case it is preferred to use the above-described apparatus and techniques. In certain cases it may be of advantage to allow the flow procedure and the curing or crosslinking reaction to proceed with a temporal offset, by running a staged heating program or a so-called heating ramp. The crosslinking temperature is preferably between 120 and 160° C. The corresponding bake time is between 10 and 60 minutes.

The free-radical polymerization is initiated and maintained preferably with actinic radiation, more preferably with electron beams or UV radiation, preferably UV radiation, especially UV-A radiation.

In terms of method the actinic radiation cure has no special features but may instead be carried out by means of the customary, known apparatus and techniques, as are described for example in German patent application DE 198 18 735 A 1, column 10, lines 31 to 61, German patent application DE 102 02 565 A1, page 9, paragraph [0092], to page 10, paragraph [0106], German patent application DE 103 16 890 A1, page 17, paragraphs [0128] to [0130], international patent application WO 94/11123, page 2, line 35, to page 3, line 6, page 3, lines 10 to 15, and page 8, lines 1 to 14, or the U.S. Pat. No. 6,743,466 B2, column 6, line 53, to column 7, line 14.

It is preferred to combine actinic radiation curing with thermal curing.

On account of the advantageous properties of the slurry of the invention and of the cured materials of the invention produced from it, the slurry of the invention and the materials of the invention can be employed with an extraordinary breadth. With preference they are used as coating materials, adhesives, and sealants for producing coatings, adhesive layers, and seals of the invention.

The coatings, adhesive layers, and seals of the invention may serve for coating, bonding, and sealing any of a very wide variety of coated and uncoated substrates.

The substrates are preferably composed of metals, plastics, wood, ceramic, stone, textile, fiber composites, leather, glass, glass fibers, glass wool and rock wool, mineral-bound and resin-bound building materials, such as plasterboard and cement slabs or roofing shingles, and also composites of these materials.

Substrates in question are preferably
means of land, water or air transport which are operated by muscle power, hot air or wind, such as cycles, railroad trolleys, rowboats, sailboats, hot air balloons, gas balloons or sailplanes, and also parts thereof,
motorized means of land, water or air transport, such as motorcycles, utility vehicles or motor vehicles, especially automobiles, watergoing or underwater craft or aircraft, and also parts thereof,
stationary floating bodies, such as buoys or parts of harbor installations,
the interior and exterior of buildings,
doors, windows, furniture, and
hollow glassware,
small industrial parts, such as nuts, bolts, hub caps or wheel rims,
containers, such as coils, freight containers or packaging,
electrical components, such as electronic windings, coils for example,
optical components,
mechanical components, and
white goods, such as household appliances, boilers, and radiators.

In particular the substrates are automobile bodies and parts thereof.

With preference the slurry of the invention is used for producing the coatings of the invention.

The slurry of the invention can be used with particular advantage as a primer, priming material, surfacer, basecoat, solid-color top coat or clearcoat material for producing single-coat or multicoat primer coating systems, corrosion control coats, antistonechip priming coats, surfacer coats, basecoats, solid-color topcoats or clearcoats.

With very particular advantage the slurry of the invention is used for producing clearcoats as part of multicoat color and/or effect paint systems, which are produced in particular by the customary, known wet-on-wet techniques (cf. German patent application DE 100 27 292 A1, page 13, paragraph [0109], to page 14, paragraph [0118]) from basecoat materials and the slurry of the invention.

On account of their particular advantages the slurry of the invention and the clearcoats of the invention produced from it are outstandingly suitable for the OEM finishing of automobiles and for the refinishing of automotive finishes, especially top-class automobile finishes. The refinish can be done over a small area, as a spot repair for example, or over a large area, either on the line at the automakers plant, as an end-of-line repair for example, or else in the paintshop.

Refinishing may be preceded by pretreatment of the damaged surfaces in the region of the sites that are to be repaired. This can be accomplished, for example, by partially dissolving the surface with an organic solvent, smoothing, sanding, corona treatment or flame treatment. It is a particular advantage of the slurry of the invention that in many cases such pretreatments can be omitted.

The multicoat color and/or effect paint systems of the invention comprising at least one clearcoat of the invention meet all of the requirements which are imposed on automotive finishes (cf. European patent EP 0 352 298 B1, page 15, line 42, to page 17, line 40) and in terms of their appearance correspond fully to a Class A surface. In particular they are particularly smooth, free even at high film thicknesses from paint defects such as craters or cracks, and are resistant to weathering, to chemicals, to condensation, to stone chipping, and to scratching.

### EXAMPLES

### Preparation Example 1

### The Preparation of a Binder (A1)

Isopropenylidenedicyclohexanol was coarsely dispersed in hydroxyethyl acrylate at 60° C. with stirring. Added to this suspension were the polyisocyanates, pentaerythritol tri/tetra-acrylate, hydroquinone monomethyl ether, 1,6-di-tert-butyl-p-cresol, and methyl ethyl ketone. After dibutyltin dilaurate had been added the reaction mixture became hotter. It was stirred at 75° C. for a number of hours until the free isocyanate group content was constant. Then glycolic acid and methanol were added and the mixture was stirred until free isocyanate groups were no longer detectable.

The hydroxyl-containing compounds and the polyisocyanates were used in amounts such as to give the equivalents ratios listed below:

| Isopropenylidenedicyclohexanol | 33.7 | eq OH |
|---|---|---|
| 2-Hydroxyethyl acrylate | 24.7 | eq OH |
| Pentaerythritol tri/tetraacrylate | 24.7 | eq OH |
| (average OH number: | | |
| 100 to 111 mg KOH/g) | | |
| Basonat ® HI 100 from BASF AG | 56.25 | eq NCO |
| Allophanate of hexamethylene | 18.75 | eq NCO |
| diisocyanate and 2-hydroxyethyl | | |
| acrylate in accordance with | | |
| international patent application | | |
| WO 00/39183 | | |
| Desmodur ® W from Bayer AG | 25 | eq NCO |
| Hydroquinone monomethyl ether | 0.05% by weight based on solids | |
| 1,6-Di-tert-butyl-p-cresol | 0.1% by weight based on solids | |
| Methyl ethyl ketone | corresponding to a solids content | |
| | of 70% by weight | |
| Dibutyltin dilaurate | 0.02% by weight based on solids | |
| Glycolic acid | 6.8 | eq OH |
| Methanol | 10.1 | eq OH |

The resulting binder (A1) had a glass transition temperature of 2.5° C., a viscosity at 23° C. of 2.0 Pas, an olefinically unsaturated double bond content of 3.12 eq/kg solids, and an acid number of 11.41 mg KOH/g solids. It was outstandingly suitable for preparing clearcoat slurries.

### Example 1

### The Preparation of a Clearcoat Slurry

738.165 parts by weight of the solution of the binder (A1) from Preparation Example 1, 10.438 parts by weight of a 50 percent strength solution of Tinuvin® CGL 052 (light stabilizer from Ciba Specialty Chemicals, containing one triazine group and two cyclic, sterically hindered amino ether groups) in methyl ethyl ketone, 9.185 parts by weight of Tinuvin® 400 (light stabilizer from Ciba Specialty Chemicals), 7.228 parts by weight of Lutensol® AT 50 (wetting agent from BASF AG), 8.246 parts by weight of trimethylamine, 20.876 parts by weight of a photoinitiator mixture of Irgacure® 184 from Ciba Specialty Chemicals and Lucirin® TPO from BASF AG (weight ratio 5:1) were mixed with one another. The resulting mixture was dispersed in 1004 parts by weight of deionized water. 0.117 part by weight of ammonium acetate was added to this dispersion. The degree of neutralization of the binder (B1) was 75%. The dispersion was subsequently filtered through a 1 μm Cuno® white filter.

The filtered dispersion was stirred in an open vessel at room temperature for 24 hours so that the methyl ethyl ketone evaporated.

The solvent-free dispersion was made up with 0.788 part by weight of Baysilone® A13468 (flow control agent from Borchers) and 15.776 parts by weight of Acrysol® RM-8W (nonionic associative thickener from Rohm & Haas).

The z-mean average particle size of the resulting clearcoat slurry was measured by means of photon correlation spectroscopy (Malvern Zetasizer® 1000); it was 140 nm.

The clearcoat slurry had a solids content of 36.2% by weight. It was outstandingly suitable for producing multicoat color and/or effect paint systems for automobiles.

### Example 2

### The Production of Multicoat Color Paint Systems

The multicoat color paint systems were produced using steel test panels which had been coated with a customary, known, cathodically deposited, and baked electrocoat. Atop the electrocoats in each case was applied a film of a customary, known water-based surfacer from BASF Coatings AG and a film of a customary, known, black aqueous basecoat material from BASF Coatings AG, both films being applied wet-on-wet. Following their application the films were each subjected to initial drying at 80° C. for 10 minutes.

Subsequently the clearcoat slurry of Example 1 was applied in wedge form to the dried basecoat film, so that drying of the resulting clearcoat film and joint curing of the surfacer film, basecoat film, and clearcoat film resulted in a wedge-shaped clearcoat with a thickness of 10 to 100 μm. Curing itself was accomplished thermally at 155° C. for 15 minutes and with UV radiation in a dose of 1.5 J/cm² (iron-doped mercury vapor lamp from IST) under an oxygen-depleted atmosphere (1% by volume oxygen). Even at a film thickness >80 μm the clearcoat was free from craters, mud cracking and microdefects (“starry sky”).

Additionally, atop the dried basecoat film, the clearcoat slurry of Example 1 was applied in a uniform thickness, so that drying of the resulting clearcoat film and joint curing of the surfacer film, basecoat film, and clearcoat film resulted in a clearcoat having a film thickness of 40 μm. Here again, curing itself took place thermally at 155° C. in a forced-air oven for 15 minutes and with UV radiation in a dose of 1.5 J/cm² (iron-doped mercury vapor lamp from IST) under an oxygen-depleted atmosphere (1% by volume oxygen).

The resultant black multicoat paint systems were particularly highly bright, glossy, chemical resistant, stonechip resistant, hard, flexible, scratch resistant, and condensation resistant, as could be underscored by means of the experimental results below:

### Chemical Resistance:

DaimlerChrysler Gradient Oven Test

| Test substance | visible damage from |
|---|---|
| Sulfuric acid: | 44° C. |
| NaOH: | 48° C. |
| Tree resin: | >75° C. |
| Deionized water: | >75° C. |

### Condensation:

Constant Conditions Test (CC 240 h)

| | |
|---|---|
| Degree of blistering: | 0 |
| Size: | 0 |
| Notes: | slight swelling, slight blushing |
| Cross-cut test with adhesive | GT-1 |
| tape removal: | |

### Hardness:

Fischerscope Penetration Hardness:

| Universal hardness: | 137.4 N/mm² at 25.6 mN |
|---|---|
| average depth of penetration: | 2.66 μm |
| relative elastic resilience: | 64.5% |
| Creep at 25.6 mN: | 10.74% |
| Creep at 0.4 mN: | 33.64% |

### Stone Chipping:

VDA:

| | |
|---|---|
| Index: | 1.5 |
| Rusting: | 0.5 |
| Ball impact: | satisfactory |

### Scratch Resistance:

Amtec-Kistler laboratory wash unit:

| Initial gloss (20°): | 89 units |
|---|---|
| Residual gloss without cleaning: | 65 units |
| Residual gloss after cleaning: | 71 units |
| Residual gloss: | 81% |

Sand test (cf. German patent application
DE 198 39 453 A1, page 9, lines 1 to 63):

| | |
|---|---|
| Residual gloss: | 84% |

1. An aqueous, structurally viscous powder dispersion, comprising:
particles (A), which are solid, highly viscous, or a combination thereof are dimensionally stable under storage and application conditions, have a z-mean average particle size as measured by photon correlation spectroscopy of 80 to 750 nm, and comprising at least one free-radically crosslinkable binder (A1) having a glass transition temperature of −70 to +50° C., an olefinically unsaturated double bond content of 2 to 10 eq/kg and an acid group content of 0.05 to 15 eq/kg, in an amount, based on (A), of 50 to 100% by weight,
wherein the aqueous, structurally viscous powder dispersion is substantially or entirely free from volatile organic compounds, and is curable by free-radical polymerization.

2. The aqueous, structurally viscous powder dispersion of claim 1, wherein the at least one free-radically crosslinkable binder (A1) has a number-average molecular weight of 1000 to 50 000 daltons.

3. The aqueous, structurally viscous powder dispersion of claim 1, wherein the olefinically unsaturated double bonds are in groups selected from the group consisting of (meth)acrylate, ethacrylate, crotonate, cinnamate, vinyl ether, vinyl ester, dicyclopentadienyl, norbornenyl, isoprenyl, isopropenyl, allyl, butenyl, dicyclopentadienyl ether, norbornenyl ether, isoprenyl ether, isopropenyl ether, allyl ether butenyl ether, dicyclopentadienyl ester, norbornenyl ester, isoprenyl ester, isopropenyl ester, allyl ester, butenyl ester, and a combination thereof.

4. The aqueous structurally viscous powder dispersion of claim 3, wherein the olefinically unsaturated double bonds are in (meth)acrylate groups.

5. The aqueous structurally viscous powder dispersion of claim 1, wherein the at least one free-radically crosslinkable binder (A1) is selected from the group consisting of oligomeric and polymeric epoxy(meth)acrylates, urethane (meth)acrylates and carbonate (meth)acrylates.

6. The aqueous, structurally viscous powder dispersion of claim 5, wherein the at least one free-radically crosslinkable binder (A1) is an oligomeric or polymeric urethane (meth)acrylate.

7. The aqueous structurally viscous powder dispersion of claim 1, wherein the particles (A) have a z-mean average particle size as measured by photon correlation spectroscopy of 80 to 400 nm.

8. The aqueous, structurally viscous powder dispersion of claim 1, further comprising at least one additive (A2) selected from the group consisting of salts which can be decomposed thermally without residue, salts which can be decomposed thermally substantially without residue; binders other than the at least one free-radically crosslinkable binder (A1) and curable physically, thermally or with actinic radiation; neutralizing agents; thermally curable reactive diluents; reactive diluents curable with actinic radiation; opaque color pigments, transparent color pigments, opaque effect pigments, transparent effect pigments; molecularly dispersely soluble dyes; opaque fillers, transparent fillers; nanoparticles; light stabilizers; antioxidants; devolatilizers; wetting agents; emulsifiers; slip additives; polymerization inhibitors; free-radical polymerization initiators, photoinitiators; thermolabile free-radical initiators; adhesion promoters; flow control agents; film-forming assistants; Theological assistants, thickeners, structurally viscous sag control agents, flame retardants; corrosion inhibitors; free-flow aids; waxes; siccatives; biocides, matting agents, and a combination thereof.

9. A process for preparing the aqueous, structurally viscous powder dispersion of claim 1, comprising dispersing the particles (A) in an aqueous medium (B).

10. The process of claim 9, wherein dispersing the particles (A) in the aqueous medium (B) comprises:
dissolving the at least one free-radically crosslinkable binders (A1) and, optionally, an additives (A2) in an organic solvent to produce a solution;
dispersing the solution in water in the presence of a neutralizing agent to produce a dispersion;
diluting the dispersion with water to produce a water-in-oil emulsion, which is further diluted to form an oil-in-water emulsion; and
removing the organic solvents from the oil-in-water emulsion.

11. A coating material, adhesive or sealant for producing a coating adhesive layer or seal comprising the aqueous, structurally viscous powder dispersion of claim 1.

12. The coating material adhesive or sealant for producing a coating adhesive layer or seal of claim 11, wherein the coating material is a primer, priming material, surfacer, basecoat, solid-color topcoat or clearcoat material for producing single-coat or multicoat primer coating systems, corrosion control coats, antistonechip priming coats, surfacer coats, basecoats, solid-color topcoats or clearcoats.

13. The coating material adhesive or sealant for producing a coating adhesive layer or seal of claim 12, wherein the clearcoat material serves for producing single-coat or multicoat clearcoat systems as part of multicoat color and/or effect paint systems.

14. The coating material adhesive or sealant for producing a coating adhesive layer or seal of claim 13, wherein the multicoat color and/or effect paint systems are produced with the aid of wet-on-wet techniques.

15. The coating material adhesive or sealant for producing a coating adhesive layer or seal of claim 11, wherein the free-radical polymerization is initiated and maintained thermally and/or with actinic radiation.
